(19) United States
(12) Patent Application Publication
(10) Pub. No.: US 2018/0200909 A1
(43) Pub. Date: Jul. 19, 2018

(54) PLUNGE SLITTING WITH ENHANCED SCRAP THREADING CAPABILITY USING MULTIPLE SIZE KNIVES

(71) Applicant: BUTECH, INC., Salem, OH (US)

(72) Inventors: John R. Buta, Salem, OH (US); Jason Cuff, Columbiana, OH (US); Jason Gustwiller, Poland, OH (US)

(73) Assignee: BUTECH, INC., Salem, OH (US)

(21) Appl. No.: 15/872,311

(22) Filed: Jan. 16, 2018

Related U.S. Application Data
(60) Provisional application No. 62/447,613, filed on Jan. 18, 2017.

(51) Int. Cl. B26D 7/20

(52) U.S. Cl. CPC B26D 7/20; B26D 2007/202

(57) ABSTRACT

A slitting machine for threading scrap material has first and second arbors. A first set of rotary knives are disposed on each of the first and second arbors having a first diameter. A second set of rotary knives are disposed on each of the first and second arbors having a second diameter. The second diameter is smaller than the first diameter. As the arbor gap is closed, the first set of rotary knives cut edge trim and when the arbor gap is further closed, the second set of rotary knives cut mutts from the strip.

### CLAIM OF PRIORITY

This application claims priority from Provisional Patent Application Ser. No. 62/447,613 filed on Jan. 18, 2017, the entirety of which is incorporated by reference herein.

### BACKGROUND OF THE DISCLOSURE

In processing metal coils, both ferrous and non-ferrous, slitting lines are used to reduce the width of an incoming coil by cutting it into a series of narrow coils. At the entry end of the line a coil is mounted on a mandrel and unwound. The unwound material is referred to as “strip”. The leading edge of the strip is passed through a slitting machine that slices the strip longitudinally into multiple widths (these portions are often referred to as “mults”) that are then rewound on a recoiling mandrel. The mults are then discharged and dealt with as individual narrow coils. The number of mults can vary from as little as two to as many as thirty or more.

Referring now to FIG. 1, a typical slitting machine A is shown which includes a pair of parallel arbors 10, 11 that are tooled with one or more rotary knives 12. The knives are typically hardened steel discs, having a bore that corresponds to the arbor diameter. The knives are mounted by sliding them onto the arbor face and then spacers 13 are slid onto the arbor between adjacent knives. On a given arbor, the distance between adjacent knives establishes the width of the mult that will be produced in that zone. There is a longitudinal key (not shown) that engages the knives and also a slot in the arbor. The key serves as a way of transmitting the power (i.e., torque) from the arbor to the knives.

The upper and lower arbors 10, 11 are tooled with the same spacing between adjacent knives but the arrangement is such that the upper knives versus the lower knives are offset to each other by essentially the width of a knife. As seen in FIG. 1, in a typical slitting machine all the knives 12 can be the same diameter and width. The spacers 13 between the knives can have additional “rubbers” or rubber sleeves 14 slid over the outer diameter of the spacers. The rubber sleeves 14 serve as strippers that keep the mults from wrapping themselves around the flanks of the knives. The rubber sleeves are essentially the same diameter as the outer diameter (OD) of the knives themselves.

In a parallel fashion, one of the arbors 10, 11 is adjustable relative to the other arbor such that the vertical gap between the knives can be adjusted. Typically to make a cut, the vertical gap G between the upper and lower arbors has to be adjusted just right. If the gap is too wide, the strip S will not be cut. If the gap is too small, it may result in poor cut quality (i.e., bad edges). When the strip is “cut” the cut zone includes a zone of penetration and a zone of fracture through the thickness of the strip. The amount of penetration (i.e., knife gap) required to cause the fracture, depends on strip material properties.

When the strip is cut into mults, the leading edge of the strip can cause issues with threading the leading edge through the rest of the line downstream of the slitter.

For example, the individual mult leading edges want to curl up and down, each adjacent mult curls in the opposite direction of its neighbor, thus requiring special handling during the threading of the line.

To avoid this situation, it has become common practice for operators to vary the gap G between the slitting arbors. When the leading edge of the strip presents itself to the slitting machine, the gap between the upper and lower knives is adjusted too wide to effect the cut. After the leading edge is through the slitter, one of the slitter arbors is adjusted to close the gap between the upper and lower knives to a point where the material is “cut”. This technique leaves the leading edge of the strip with a length that is uncut and essentially one whole width of material thus making it much easier to thread the line. Once the line is threaded and the leading edge is close to the recoiler, the leading edge “uncut” zone is sheared off. This entire operator practice is often referred to as “plunge” slitting.

Plunge slitting is an improvement in threading the line, but it is an imperfect solution. The purpose of the present disclosure is to further improve the threading of slitting lines. In the process of slitting, in addition to the mults, the slitter also trims the outside edges (two edges) of the parent coil. This edge trimming accomplishes two things: 1) it establishes an exact width for the outermost two mults (one on each edge of the coil); and 2) it trims away bad edges from each edge of the parent coil (examples of bad edges or edges which could have cracks or could have material handling damage from prior handling of the parent coil).

Each edge trim includes a relatively narrow ribbon of scrap material. The scrap is removed from the line just downstream of the slitter. The two ribbons of scrap can be chopped into discrete scrap pieces (such was discussed in U.S. Pat. No. 7,901,271 related to scrap choppers which is hereby incorporated by reference in its entirety) or the scrap could be wound onto scrap winders.

When operators use plunge slitting, the leading edge of the strip remains uncut and includes the “scrap” edges. This requires the operator to stop the line and enter the line to physically and manually cut the scrap away from the uncut zone thus allowing the scrap to be redirected to the scrap chopper chutes or to scrap winders. This practice reduces productivity and introduces an unsafe condition for the operator.

Another problem with existing slitters is that all of the knives are of a fixed size and same diameter. As a result, the edge trim and all of the mults are always cut. There is no existing way to only cut the edge trim without also cutting all of the mults.

Thus, there is a need for a method of improving the threading of slitting lines by incorporating knives of various diameters and sizes which overcomes the above mentioned deficiencies while providing better overall results.

### SUMMARY OF THE DISCLOSURE

The present disclosure relates to plunge slitting. More particularly, it relates to plunge slitting with improved scrap threading capability by using multiple size and multiple diameter knives. In accordance with one embodiment of the disclosure, a slitter and scrap chopper arrangement has knives of different sizes and diameters while stripper rubber sleeves are positioned on spacers between the knives.

In accordance with a preferred embodiment of the disclosure, a slitting machine for slitting metal strip has first and second arbors; a first set of rotary knives disposed on each of the first and second arbors having a first diameter; a second set of rotary knives disposed on each of the first and second arbors having a second diameter; where the second diameter is smaller than the first diameter.

In accordance with another embodiment of the disclosure, a method for threading metal strip through a slitting machine having provided first and second arbors including providing a first set of rotary knives having a first diameter disposed on each of the first and second arbors; providing a second set of rotary knives having a second diameter disposed on each of the first and second arbors; wherein said second diameter is smaller than the first diameter; and closing a gap between the first and second arbors to enable the first set of rotary knives to cut edge trim from the strip.

In accordance with another aspect of the disclosure, the slitter arbors close while the strip is moving. This relates to the ratio of the rate of arbor closure vs strip travel and can be implemented as an automatic sequence controlled by the operator.

When the leading edge of the strip is at the nip of the slitter arbors, the arbor gap G is commanded to close at a predetermined rate while the strip advances (continues to feed past the slitter) at an appropriate line speed, such that by the time a couple of feet of strip has passed through the nip of the slitter arbors, the slitter arbor vertical gap G has closed to a point where the knife vertical gap is tight enough to cut through the strip. This can be a fully automated sequence or can be manual with the operator controlling the sequence. The key is the timing between the vertical closure of the arbors and the speed of advance of the strip.

As the arbor gap closes it is important for the strip to be advancing otherwise the separating force between the arbors would get quite large and possibly overload the slitter arbor bearings.

In accordance with a preferred embodiment of the disclosure, strip material is fed into the line and the slitter arbor gap G is preset too large to make the cut (i.e., during initial threading through the slitter). As the strip advances to the slitter, the slitter arbors are closed further at a closure speed that is appropriate to the strip advance speed.

If only an edge trim of the strip is desired, as the arbors are closed or “plunged”, the outer larger diameter knives cut or trim the outward edge of the strip, while the inner portion of the strip remains uncut due to the inner smaller diameter knives having a gap to large to cut the strip.

If the arbors are further closed or “plunged”, then the strip mults are cut by the inner knives, while the edge trim is cut by the outer knives. When strip has advanced far enough and slitter arbors are at their final cutting gap the strip will be cut all the way through including the mults and edge trim. Both outer edges of the strip have a trim width that will “automatically” thread itself into the scrap chutes and on into the scrap choppers or down to scrap winders.

In accordance with one embodiment of the disclosure, all the inwardly positioned knives on parallel slitter arbors, except the outer pairs, are of the same diameter.

In accordance with another embodiment of the disclosure, the outer pairs of knives; i.e., one pair at each of the two outside edges, are at a diameter which is larger than the diameter of the inner knives.

In accordance with another embodiment of the disclosure, there are preferably four knives of a larger diameter while there may be multiple pairs of knives of a smaller diameter dependent on the desired results.

In accordance with another embodiment of the disclosure, for a given gap between the upper and lower arbors, the gap between the larger diameter knives will be tighter than the gap between the smaller diameter knives.

In accordance with another embodiment of the disclosure, during plunge slitting, when the gap between the smaller diameter knives is too large to cut the strip, the gap at the larger diameter knives is small enough to cut through the strip.

Other aspects of the disclosure will become apparent upon a reading and understanding of the following detailed description.

### BRIEF DESCRIPTION OF THE DRAWINGS

FIG. 1 is a perspective view of an existing slitter and scrap chopper assembly;

FIG. 2 is a perspective view of a slitter with multiple diameter knives and scrap chopper assembly in accordance with a preferred embodiment of the disclosure;

FIG. 3 is a top plan view of multiple diameter knives in accordance with a preferred embodiment of the disclosure;

FIG. 4 is a side elevational view of the knives of FIG. 3;

FIG. 5 is a front elevational view of the knives of FIG. 3;

FIG. 5A is an enlarged elevational view taken along detail B illustrating arbors plunged for edge trim only;

FIG. 5B is an enlarged elevational view taken along detail B illustrating arbors plunged to cut all mults.

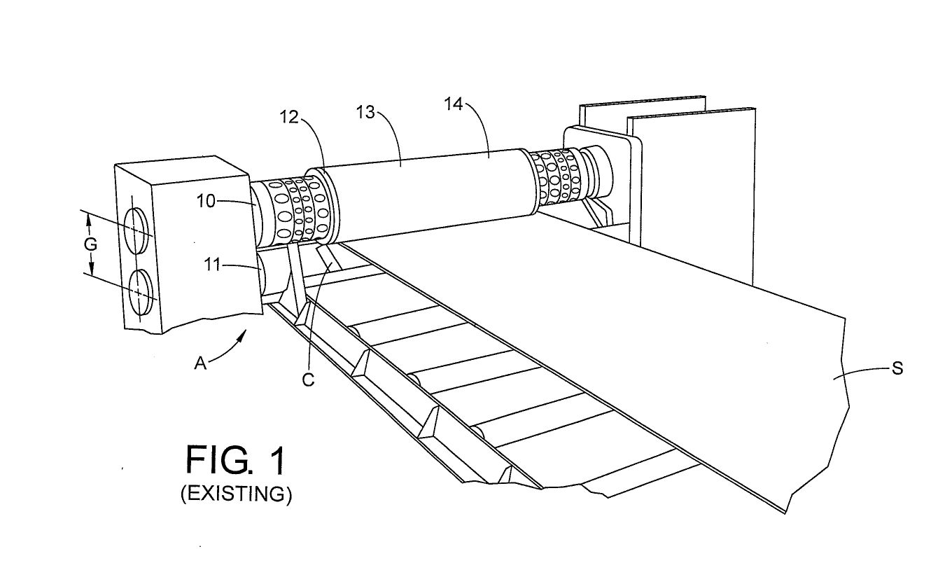

### DETAILED DESCRIPTION OF THE DISCLOSURE

The present disclosure relates to plunge slitting. More particularly, it relates to plunge slitting with improved scrap threading capability by using multiple size diameter knives.

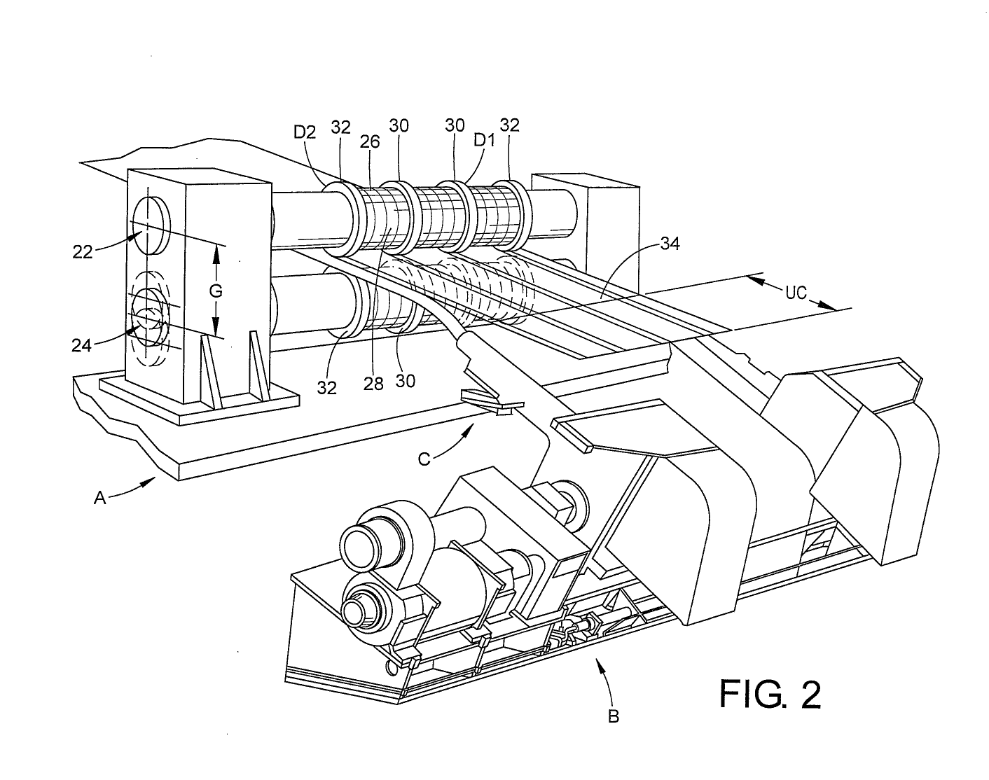

The preferred embodiment of the disclosure in shown is FIGS. 2-5B. Scrap choppers B and chutes C can be positioned immediately after slitter arbors 22, 24. FIG. 2 shows that lower slitter arbor 24 can be adjustable upwardly and downwardly to adjust the arbor gap G. Referring to FIG. 2, a slitter A and scrap chopper arrangement B and chute C are shown. The slitter and scrap chopper are shown separately for clarity. The scrap chopper B is shown to illustrate the problem of how to get the scrap trim into the chopper where the first two feet of strip, or more or less, is not cut through (i.e., the uncut zone 4C). This problem exists regardless whether a scrap chopper or scrap winder is used.

Stripper rubber sleeves 26 are positioned on spacers 28 between knives 30, 32. All the inwardly positioned knives 30 on the parallel slitter arbors 22, 24, except the outer pairs 32, are of the same diameter D1. The outer pairs of knives 32; i.e., one pair at each of the two outside edges, are at a diameter D2 which is larger diameter than D1. There are preferably four knives 32 of diameter D2 while there may be multiple pairs of knives 30 of diameter D1 dependent on the desired results. For a given gap between the upper and lower arbors 22, 24, the gap between the larger diameter knives 32 will be tighter than the gap between the smaller diameter knives 30.

In this manner, during plunge slitting, when the gap between the knives 30 is too large to cut strip 34, the gap at the knives 32 is small enough to cut through the strip. There can be multiple pairs of knives 30 dependent upon the number of mults formed on the strip. Thus the scrap (trim) is cut all the way through and threads itself into the scrap chutes. This overcomes the shortcomings of existing practice.

As the arbor gap G closes it is important for the strip 34 to be advancing otherwise the separating force between the arbors would get quite large and possibly overload the slitter arbor bearings.

In accordance with a preferred embodiment of the disclosure, strip material 34 is fed into the line and the slitter arbor gap G is preset too large to make the cut (i.e., during initial threading through the slitter). As the strip advances to the slitter, the slitter arbors are closed further at a closure speed that is appropriate to the strip advance speed.

If only an edge trim of the strip 34 is desired, as the arbors 22, 24 are closed or unplunged, the outer knives 32 cut or trim the outward edge of the strip, while the inner portions remains uncut due to the inner smaller diameter knives 30 not contacting the strip 24.

If the arbors are further closed or “plunged”, then the mults are cut by the inner knives 30, while the edge trim is cut the outer knives 32. When strip 34 has advanced far enough and slitter arbors are at their final cutting gap the strip will be cut all the way through including the mults and edge trim. Each edge has a trim width that will “automatically” thread itself into the scrap chutes and on into the scrap choppers or down to scrap winders.

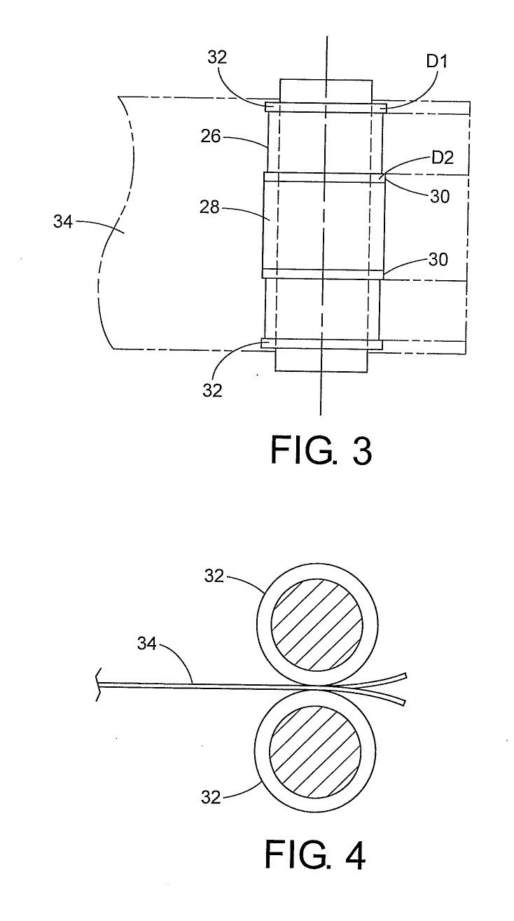

Referring now to FIGS. 3, 4, 5, a slitter with multiple diameter knives in accordance with the preferred embodiment of the disclosure is shown in more detail.

Outer knives 32 are shown to be of diameter D1 which is larger than the diameter D2 of the inner knives 30. Spacers 28 with sleeves 26 are positioned between the knives on arbors 22, 24 (FIG. 2).

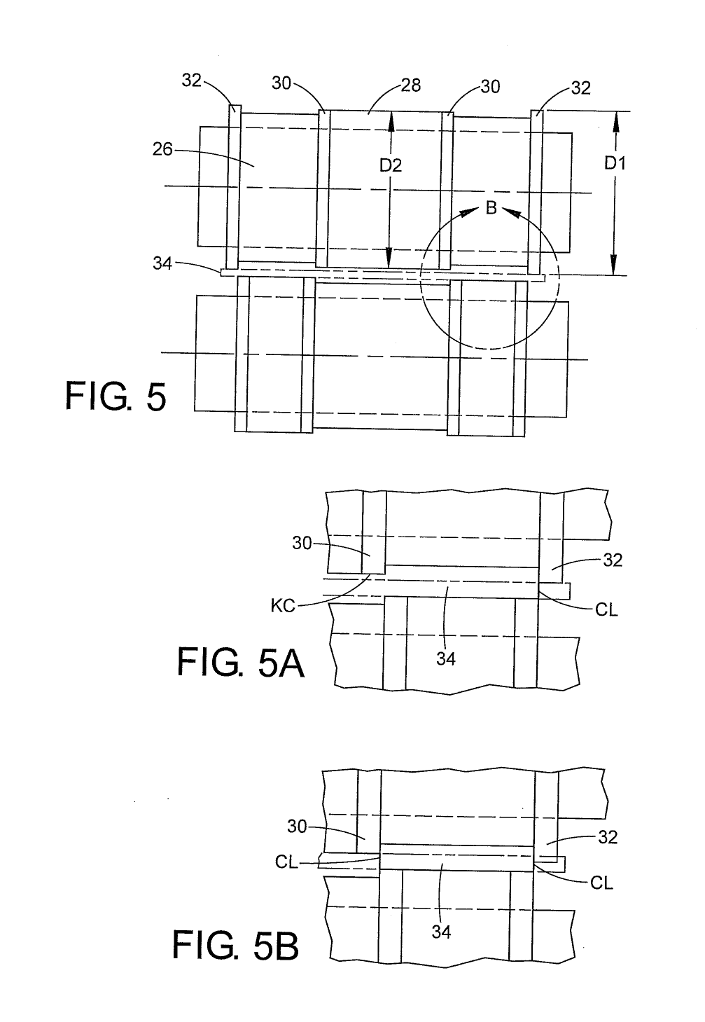

Referring to FIG. 5A, as the arbor gap G is closed, the outer knives 32 begins to form a cut line CL forming an edge trim while the inner knives 30 have a gap or knife clearance KC with the strip. The inner knives 30 do not cut the strip. Thus, only the edge trim is cut or slit from the strip by knives 32.

Referring to FIG. 5B, the arbor gap G is further closed, allowing both the outer knives 32 to form a cut line CL and the inner knives 30 to form a cut line CL. In this arrangement, the arbors are plunged to cut all of the mutts with knives 30 as well as the edge trim with knives.

The disclosure has been described with reference to a preferred embodiment. Obviously, modifications and alterations may occur to others while reading and understanding the preceding detailed description. It is intended that the disclosure includes all such modifications and alterations insofar as they come within the scope of the preceding description and appended claims.

1. A slitting machine for threading scrap material comprising:
first and second arbors;
a first set of rotary knives disposed on each of said first and second arbors, said first set of rotary knives having a first diameter;
a second set of rotary knives disposed on each of said first and second arbors, said second set of rotary knives having a second diameter;
wherein said second diameter is smaller than said first diameter.

2. The slitting machine of claim 1, whereas spacers are positioned between each of said rotary knives.

3. The slitting machines of claim 2, wherein sleeves are placed over said spacers.

4. The slitting machines of claim 1, wherein said arbors are adjustable to change a gap between said first and second arbors.

5. The slitting machine of claim 4, wherein said gap between said first and second arbors is closed while an associated strip travels through the slitting machine so that a gap between said first set of rotary knives is small enough so that said first set of rotary knives cut an edge trim from said strip.

6. The slitting machine of claim 5, wherein a gap between said second set of rotary knives is too large to cut said strip.

7. The slitting machine of claim 4, wherein said gap between said first and second arbors is closed while an associated strip travels through the slitting machine so that a gap between said second set of rotary knives is small enough so that said second set of rotary knives cut mults from said strip.

8. The slitting machine of claim 7, wherein a gap between said first set of rotary knives is small enough so that said first set of rotary knives cut an edge trim from said strip.

9. The slitting machine of claim 1, wherein a scrap chopper and chute are positioned at an end of said slitting machine.

10. A method for threading scrap material through a slitting machine comprising:
providing first and second arbors;
providing a first set of rotary knives having a first diameter disposed on each of said first and second arbors;
providing a second set of rotary knives having a second diameter disposed on each of said first and second arbors; wherein said second diameter is smaller than said first diameter;
closing a gap between said first and second arbors to enable said first set of rotary knives to cut edge trim from said strip.

11. The method of claim 10, wherein said first and second arbors are adjustable to change a gap between said first and second arbors.

12. The method of claim 11, wherein said gap between said first and second arbors is further closed while the associated strip travels through the slitting machine so that a gap between said second set of rotary knives is small enough so that said second set of rotary knives cut a mult from said strip.

13. The method of claim 10, wherein a scrap chopper and chute are positioned at an end of said slitting machine.
